(19) United States
(12) Patent Application Publication
(10) Pub. No.: US 2002/0099967 A1
(43) Pub. Date: Jul. 25, 2002

(54) Transmission method, transmission system, transmission apparatus and transmission control apparatus

(76) Inventor: Hiroshi Kawaguchi, Kanagawa (JP)

Correspondence Address: LERNER, DAVID, LITTENBERG, KRUMHOLZ & MENTLIK, LLP, 600 SOUTH AVENUE WEST, WESTFIELD, NJ, 07090-1497, US

(21) Appl. No.: 09/894,045

(22) Filed: Jun. 28, 2001

(30) Foreign Application Priority Data
Jun. 28, 2000 (JP) P2000-195021

(51) Int. Cl. G06F 1/30; G06F 15/16; H04B 14/04

(52) U.S. Cl. 713/323; 709/208; 375/242

(57) ABSTRACT

The present invention allows suspend and resume processes to be carried out properly in a network such as a network according to the IEEE1394a system. If data transmission among a plurality of devices connected to a network is executed under the control of a predetermined controller, data as to whether each device can be set in a suspend state (e.g., suspend level) is notified from each device in the network to the controller using a broadcast communications transmission interval. The controller transmits a suspend state setting command based on the data.

### CROSS-REFERENCE TO RELATED APPLICATIONS

The present application claims the benefit of Japanese Application No. P2000-195021 filed Jun. 28, 2000, the disclosure of which is hereby incorporated by reference herein.

### BACKGROUND OF THE INVENTION

The present invention relates to a transmission method and a transmission system used where data is transmitted between equipment connected to one another by a network such as a bus line according to the IEEE (The Institute of Electrical and Electronics Engineers) 1394 standard, as well as to a transmission apparatus and a transmission control apparatus which utilize this transmission method.

The development of AV or audiovisual equipment capable of mutually transmitting information through a network using an IEEE1394 standard-compliant serial data bus is underway. For data transmission through the bus, a synchronous communications mode used to transmit a relatively large capacity of moving picture data, audio data and the like in a real time manner, and an asynchronous communications mode used to reliably transmit still pictures, text data, control commands and the like are prepared and bands dedicated to the respective modes are used for the data transmission. According to the IEEE1394 system, the synchronous communications mode is referred to as “isochronous communications mode” and the asynchronous communications mode is referred to as it is.

In case of data communications in the isochronous communications mode, an apparatus set as an IRM (Isochronous Resource Manager) in the network manages channels and bands. Apparatus executing communications in the isochronous communications mode conducts processes for acquiring channels and bands to the IRM. “Channel” as used herein means a path for flowing isochronous data between a transmission side and a reception side. “Band” as used herein means the quantity of the band for the isochronous communications proportional to the magnitude of packets transmitted on one channel and inversely proportional to a transfer rate.

Using the acquired channel and band, isochronous data transmission is carried out between apparatus for which a connection setting has been made. The connections to be set include a point-to-point connection (to be referred to as “PtoP connection” hereinafter) for connecting the output plug of one apparatus to the input plug of the other apparatus, and a broadcast connection for transmitting data using a broadcasting channel.

In case of data transmission in the asynchronous communications mode, an input plug and an output plug different from those in the isochronous communications mode are set and a control process different from that in the isochronous communications mode is carried out.

The transmission processes described so far are standardized processes according to the IEEE1394-1995 standard in the IEEE1394 system. Consideration is now given to the adoption of a standard for expanding this IEEE1394-1995 standard, which standard is referred to as an IEEE1394a standard. Suspend and resume controls and commands are included in the processes specified by this IEEE1394a standard. Suspend means turning respective apparatus (nodes) connected to the bus line into sleep states so as to reduce the power consumption of the nodes. To be specific, even if nodes are physically connected to the bus line, the nodes are turned into states in which no bias is output. Also, resume means returning the nodes from the suspend states to active states which are states in which the nodes can hold original communications. An apparatus which controls communications on the bus is capable of discriminating this suspend state from a disconnect state in which nothing is connected to the bus line physically.

If the apparatus which manages communications in the network transmits a suspend setting command to set the suspend state, a desired apparatus in the network can be turned into a suspend state and the power consumption of the respective apparatus constituting the network can be reduced. Further, if many apparatus (or nodes) are connected in one network, some of the nodes are turned into suspend states, thereby making it possible to advantageously decrease transmission delay on the bus line and to enhance transmission efficiency.

Meanwhile, if the suspend and resume processes specified by the IEEE1394a standard are executed under the control of a bus manager which is a control apparatus connected to the bus line, it is possible to control the states of the respective apparatus in the network. Actually, however, it is difficult for the bus manager to judge whether or not the respective apparatus connected to the bus line can be set in suspend states. Due to this, the suspend and resume processes may be able to be used only when the respective apparatus connected to the bus line are turned into suspend states after the apparatus judge themselves that their states can be set at suspend states. For example, it is possible to set the state of an apparatus at a suspend state only when the apparatus turns into a standby state by the operation of a power key provided on the apparatus.

While the problems with the apparatus connected to the IEEE1394 bus line have been described above, the same problems occur in a network in which suspend and resume processes can be carried out in response to instructions from the other equipment.

It is, therefore, an object of the present invention to allow suspend and resume processes to be properly carried out in a network of this type.

### SUMMARY OF THE INVENTION

The first aspect of the invention provides a method for transmitting data among a plurality of devices connected to a network under control of a controller. The method includes transmitting from each of the plurality of devices, using a broadcast communications transmission interval, suspend state data indicating whether the transmitting device can be set in a suspend state, and receiving the suspend state data in the controller.

According to the first aspect of the invention, it is possible to transmit the suspend state data from each device in the network to the controller using a broadcast communications transmission interval, and it is possible for the controller to determine whether each device connected in the network can be set in the suspend state.

A transmission system in accordance with a second aspect of the invention includes a plurality of devices connected to a network so that the plurality of devices can transmit data to one another, the plurality of devices including a first device and a second device. The first device includes a memory for holding suspend state data indicating whether each of the plurality of devices can be set in a suspend state; and an output unit operable to output the suspend state data to a broadcast communications transmission interval of the network. The second device includes a receiver operable to receive the suspend state data output to the network; and a controller operable to determine whether the first device can be set in the suspend state based on the suspend state data received by the receiver, and to control the first device based on the determination.

According to the second aspect of the invention, the first device can transmit the suspend state data to the second device using the broadcast communications transmission interval, and the second device can determine whether the first device can be set in the suspend state.

In accordance with a third aspect of the invention, there is provided a transmission apparatus connected to a network. The transmission apparatus includes a memory operable to hold suspend state data indicating whether the transmission apparatus can be set in a suspend state; and an output unit operable to output the suspend state data held by the memory to a broadcast communications transmission interval of the network.

According to the third aspect of the invention, the suspend state data can be transmitted to other devices connected to the network over the broadcast communications transmission interval.

A transmission control apparatus in accordance with a fourth aspect of the invention controls transmission among a plurality of devices in a network, the plurality of devices being mutually connected in a data transmittable state. The transmission control apparatus includes a receiver operable to receive suspend state data transmitted to a broadcast communications transmission interval of the network, the suspend state data indicating whether each of the plurality of devices can be set in a suspend state; a controller operable to determine whether each of the plurality of devices in the network can be set in the suspend state based on the suspend state data received by the receiver, and to generate a command for controlling a state of each of the plurality of devices based on the determination; and a transmitter operable to transmit the commands to the network.

According to the fourth aspect of the invention, the transmission control apparatus can determine whether each of the plurality of devices in the network can be set in the suspend state from the suspend state data transmitted from the respective devices in the network over the broadcast communications transmission interval, and can transmit a suspend state setting command only to the devices determined to be permitted to be set in the suspend state.

### BRIEF DESCRIPTION OF THE DRAWINGS

FIG. 1 is a block diagram showing one example of the overall constitution of a system in one embodiment according to the present invention;

FIG. 2 is a block diagram showing one example of the internal constitution of an IRD (or digital satellite broadcast receiver) in one embodiment according to the present invention;

FIG. 3 is a block diagram showing one example of the internal constitution of a television receiver in one embodiment according to the present invention;

FIG. 4 is a block diagram showing one example of the internal constitution of a video recording and reproducing apparatus in one embodiment according to the present invention;

FIG. 5 is an explanatory view showing one example of a data transmission cycle structure on an IEEE1394 bus;

FIG. 6 is an explanatory view showing one example of the address space structure of a CRS architecture;

FIG. 7 is an explanatory view showing the positions, names and functions of important CRS's;

FIG. 8 is an explanatory view showing one example of a general ROM format;

FIG. 9 is an explanatory view showing one example of a bus info block, a root directory and a unit directory;

FIG. 10 is an explanatory view showing one example of the constitution of a PCR;

FIGS. 11A to 11D are explanatory views showing one example of the constitutions of an oMPR, an oPCR, an iMPR and an iPCR;

FIG. 12 is an explanatory view showing one example of the relationship among a plug, a plug control register and a transmission channel;

FIG. 13 is an explanatory view showing one example of the constitution of an asynchronous stream packet;

FIG. 14 is an explanatory view showing one example of the constitution of a GASP (global asynchronous stream packet);

FIG. 15 is an explanatory view showing one example of the constitution of a suspend data transmission packet in one embodiment according to the present invention;

FIG. 16 is an explanatory view showing the transition of a node state in one embodiment according to the present invention;

FIG. 17 is a flow chart showing one example of the suspend data transmission process of each node in one embodiment according to the present invention;

FIG. 18 is a flow chart showing one example of the suspend data reception process of a bus manager in one embodiment according to the present invention;

FIG. 19 is an explanatory view showing one example of suspend data held in the bus manager in one embodiment according to the present invention; and

FIG. 20 is a flow chart showing one example of the suspend command transmission process of the bus manager in one embodiment according to the present invention.

### DETAILED DESCRIPTION

One embodiment of the present invention will be described hereinafter with reference to the accompanying drawings.

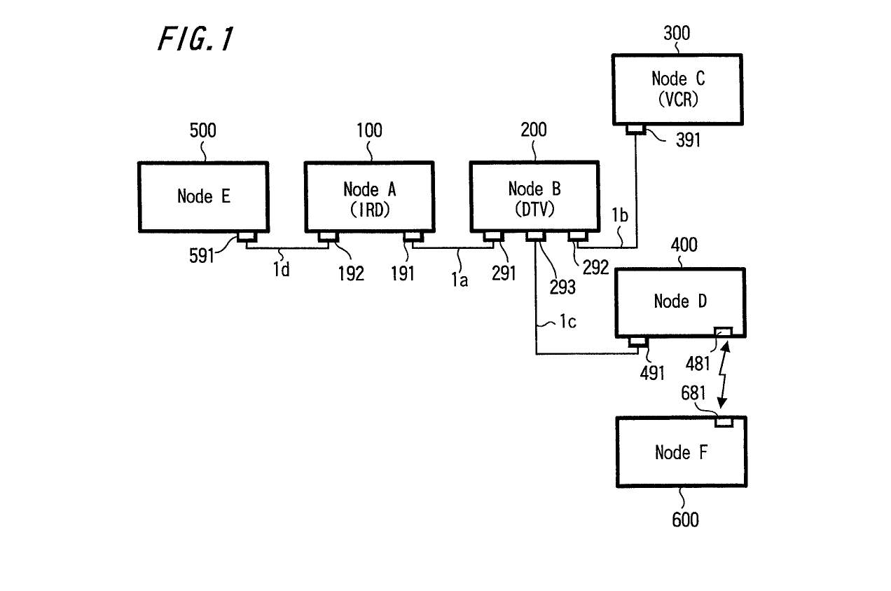

Description will be given to one example of the constitution of a network system to which the present invention is applied with reference to FIG. 1. It is assumed herein that in this network system, a plurality of devices are connected through cables 1a, 1b, 1c and 1d constituting an IEEE1394 serial data bus. As shown in FIG. 1, five devices 100, 200, 300, 400 and 500, each provided with IEEE1394 bus connection ports, are connected through the cables 1a to 1d in sequence. In the network based on the IEEE1394 serial data bus, each device is referred to as a node. In this example, the devices 100, 200, 300, 400 and 500 are referred to as nodes A, B, C, D and E, respectively.

The device 100 or node A is provided with two ports 191 and 192 and is connected to a port 291 of the device 200 through the cable 1a and also to a port 591 of the device 500 through the cable 1d. The device 200 or node B is provided with three ports 291, 292 and 293 and is connected to a port 391 of the device 300 through the cable 1b and also to a port 491 of the device 400 through the cable 1c.

Further, in FIG. 1, the device 400 or node D is provided with an optical communication port 481. The node D carries out optical communications with an optical communication port 681 of another device 600 disposed in a range in which light can be emitted from the port 481, thereby providing a constitution capable of adding this device 600 to the network. The device 600 is referred to as or denoted by a node F.

In this embodiment, the device 100 (or node A) is a digital satellite broadcast receiver referred to as an IRD (Integrated Receiver Decoder). The device 200 (or node B) is a digital television receiver (DTV) receiving digitally broadcast data and digitally broadcast pictures. The device 300 is a video cassette recorder (VCR) for recording and reproducing pictures and voice to and from a video tape.

As can be seen, by connecting the IRD 100, the television receiver 200 and the video cassette recorder 300 in the network, the picture data and voice data of digital satellite broadcasts, for example, received by the IRD 100 can be transmitted to the television receiver 200 and the television receiver 200 can receive pictures. In addition, picture data and voice data can be transmitted to the video cassette recorder 300 and the video cassette recorder 300 can record the received data on a tape cassette. Further, the picture data and voice data reproduced and obtained by the video cassette recorder 300 can be transmitted to and received by the television receiver 200. Moreover, picture data, voice data and the other data can be transmitted among the other devices 400, 500 and 600 connected in the network.

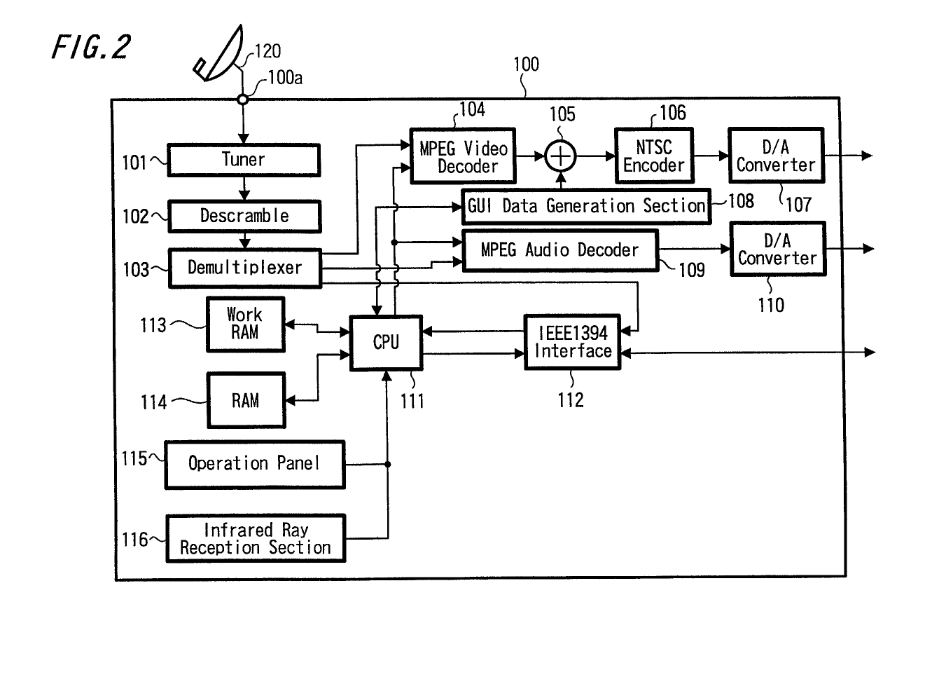

FIG. 2 shows a concrete example of the constitution of the IRD 100. A broadcast radio wave from a satellite is received by an antenna 120, input into a terminal 100a and then supplied to a tuner 101 provided in the IRD 100 and serving as program select means. The respective circuits in the IRD 100 operate based on the control of a central processing unit (CPU) 111. The IRD 100 obtains a predetermined channel signal by the tuner 101. The reception signal obtained by the tuner 101 is supplied to a descramble circuit 102.

The descramble circuit 102 extracts multiplexed data on a subscribed channel (or non-ciphered channel) from among the reception data and supplies the extracted multiplexed data to a demultiplexer 103 based on cipher key information on a subscribed channels stored in an IC card (not shown) inserted into the main body of the IRD 100.

The demultiplexer 103 rearranges the supplied multiplexed data according to the channels, extracts only the channel which a user designates, outputs a video stream consisting of picture part packets to an MPEG video decoder 104 and outputs an overlap stream consisting of voice part packets to an MPEG audio decoder 109.

The MPEG video decoder 104 decodes the video stream into picture data which is not subjected to compression encoding and outputs the decoded picture data to an NTSC encoder 106 through an adder 105. The NTSC encoder 106 converts the picture data into a luminance signal and a color difference signal according to the NTSC system and outputs these signals as video data according to the NTSC system to a digital/analog converter 107. The digital/analog converter 107 converts the NTSC data into an analog video signal and supplies the converted analog video signal to a receiver (not shown) directly connected thereto by an analog signal line.

Also, under the control of the CPU 111, the IRD 100 in this embodiment includes a GUI data generation section 108 which generates picture data for various types of display for a graphical user interface (GUI). GUI picture data (or display data) generated by the GUI data generation section 108 is supplied to the adder 105 and superimposed on picture data output from the MPEG video decoder 104 so that pictures for the GUI can be superimposed on received broadcast pictures.

An MPEG audio decoder 109 decodes the audio stream into PCM audio data which is not subjected to compression encoding and outputs the PCM audio data to a digital/analog converter 110.

The digital/analog converter 110 converts the PCM audio data into an analog signal to thereby generate an LCh audio signal and an RCh audio signal and outputs these signals as voice through the speaker (not shown) of an audio reproduction system connected to the converter 110.

Further, the IRD 100 in this embodiment is constituted so that the video stream and the audio stream extracted by the demultiplexer 103 can be supplied to an IEEE1394 interface section 112 and output to an IEEE1394 bus line 1 connected to the interface section 112. The video stream and audio stream thus received are output in an isochronous transfer mode. Further, the IRD 100 is constituted so that if the GUI data generation section 108 generates GUI picture data, the picture data can be supplied to the interface section 112 through the CPU 111 and output from the interface section 112 to the bus line 1.

A work RAM 113 and a RAM 114 are connected to the CPU 111. Using these memories, the CPU 111 carries out a control process. Further, an operation instruction from an operation panel 115 and a remote control signal from an infrared ray reception section 116 are supplied to the CPU 111 to allow executing operations based on various operation instructions. In addition, the CPU 111 is constituted to be capable of judging commands and responses transmitted from the bus line 1 to the interface section 112. In this embodiment, since the IRD 100 is used as a bus manager, data as to whether or not the states of the respective devices in the network can be set at suspend states are stored and held in, for example, a RAM 114 under the control of the CPU 111, which data will be described later.

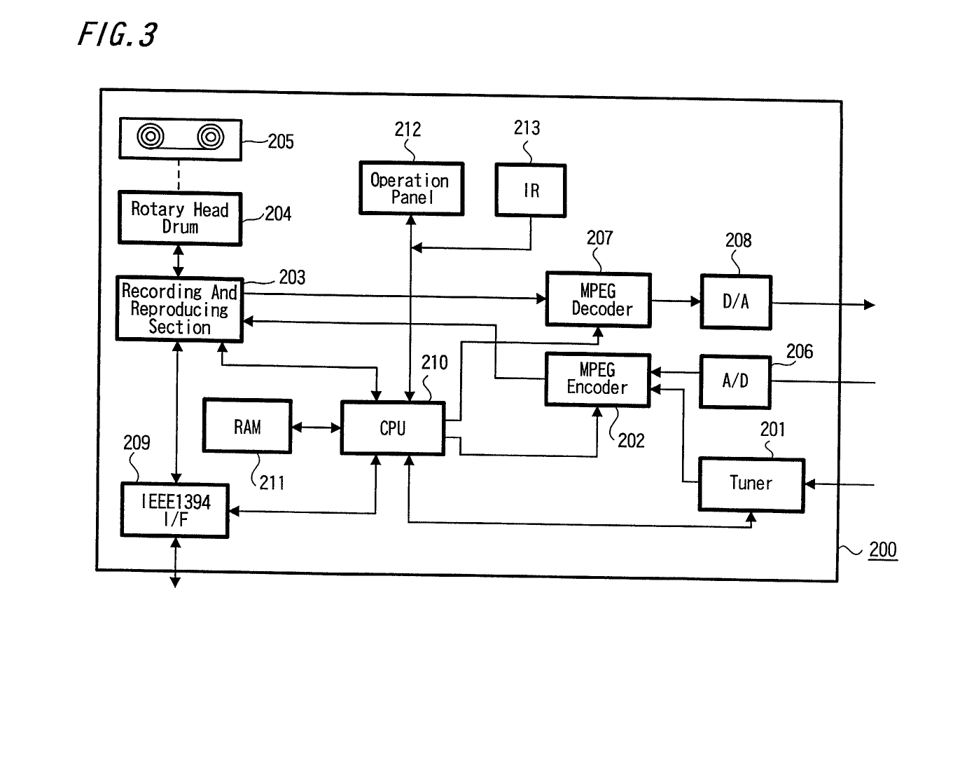

FIG. 3 is a block diagram showing one example of the constitution of a video cassette recorder (VCR) 200.

As a recording system, the video cassette recorder 200 is constituted as follows. A tuner 201 built in the video cassette recorder 200 receives a predetermined channel. Digital broadcast data obtained by receiving the predetermined channel is supplied to an MPEG (Motion Picture Experts Group) encoder 202. The MPEG encoder 202 encodes the digital broadcast data into picture data and voice data according to a system suitable for recording, e.g., an MPEG2 system. If the received broadcast data is data according to the MPEG2 system, the encoder 202 does not conduct any processing of the broadcast data.

The data encoded by the MPEG encoder 202 is supplied to a recording and reproducing section 203, which section conducts a recording process to the picture data and voice data thus encoded. The recorded data thus processed is supplied to a recording head in a rotary head drum 204 to thereby record the recorded data on a magnetic tape in a tape cassette 205.

In case of analog picture and voice signals input from an external unit, an analog/digital converter 206 converts the analog picture signal and analog voice signal into digital data. The MPEG encoder 202 encodes the digital data into picture data and voice data according to, for example, the MPEG2 system and supplies the encoded data to the recording and reproducing section 203. The recording and reproducing section 203 conducts a recording process with respect to the encoded data and supplies the recorded data thus processed to the recording head in the rotary head drum 204. The recording head records the recorded data on the magnetic tape in the tape cassette 205.

As a reproduction system, the video cassette recorder 200 is constituted as follows. The rotary head drum 204 reproduces the magnetic tape in the tape cassette 205 to thereby obtain signals. The recording and reproducing section 203 conducts a reproduction process to the signals to thereby obtain picture data and voice data. The picture data and voice data are supplied to an MPEG decoder 207, which decoder decodes the picture data and voice data of, for example, the MPEG2 system. The decoded data is supplied to a digital/analog converter 208, which converter converts the data into an analog picture signal and an analog voice signal and outputs the converted signals to an external unit.

Further, the video cassette recorder 200 in this embodiment includes an interface section 209 for connecting to the IEEE1394 bus. Picture data and voice data obtained by the interface section 209 from the IEEE1394 bus are supplied to the recording and reproducing section 203 to thereby allow the picture data and the voice data thus supplied to be recorded on the magnetic tape in the tape cassette 205. In addition, picture data and voice data reproduced from the magnetic tape in the tape cassette 205 are supplied from the recording and reproducing section 203 to the interface section 209 to thereby allow the picture data and the voice data to be output to the IEEE1394 bus.

At the time of data transmission through this interface section 209, if a recording system (e.g., MPEG2 system stated above) for the video cassette recorder 200 to record the data on the medium (magnetic tape) differs from the system of the data transmitted on the IEEE1394 bus, then system conversion may be conducted in a circuit in the video cassette recorder 200.

The recording process and the reproduction process of the video cassette recorder 200 and the transmission process of the recorder 200 through the interface section 209 are executed under the control of a central processing unit (CPU) 210. A memory 211 serving as a work PAM is connected to the CPU 210. Also, operation information from an operation panel 212 and control information received by an infrared ray reception section 213 from a remote controller are supplied to the CPU 210 and the CPU 210 conducts operation control in accordance with the operation information and the control information. Further, if the interface section 209 receives control data such as an AV/C command to be described later through the IEEE1394 bus, the interface 209 supplies the control data to the CPU 210 to allow the CPU 210 to conduct operation control in accordance with the control data.

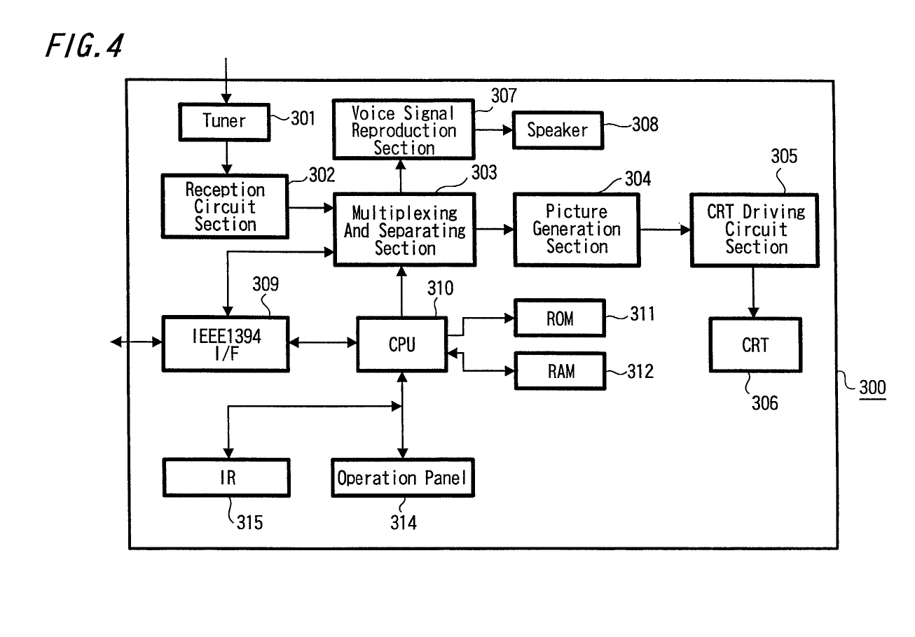

FIG. 4 is a block diagram showing one example of the constitution of the television receiver 300. The television receiver 300 in this embodiment is a device referred to as a digital television receiver for receiving digital broadcasts and displaying the received digital broadcasts.

A tuner 301 to which an antenna, not shown, is connected receives a predetermined channel. Digital broadcast data obtained by receiving the predetermined channel is supplied to a reception circuit section 302, which section decodes the digital broadcast data. The broadcast data thus decoded is supplied to a multiplexing and separating section 303, which section separates the decoded data into picture data and voice data. The picture data thus separated is supplied to a picture generation section 304. The picture generation section 304 conducts a picture reception process to the picture data. Using the signal thus processed, a CRT driving circuit section 305 drives a cathode ray tube (or CRT) 306 to allow pictures to be displayed. Also, the voice data separated by the multiplexing and separating section 303 is supplied to a voice signal reproduction section 307. The voice signal reproduction section 307 conducts voice processes such as analog conversion and amplification to the voice data to obtain voice signals. The voice signals thus obtained are supplied to a speaker 308 and output from the speaker 308.

The television receiver 300 also includes an interface section 309 for connecting to the IEEE1394 bus so that picture data and voice data obtained from the IEEE1394 bus to the interface section 309 can be supplied to the multiplexing and separating section 303, and so that pictures can be displayed on the CRT 306 and voices can be output from the speaker 308. In addition, the picture data and the voice data received by the tuner 301 can be supplied from the multiplexing and separating section 303 to the interface section 309 and output from the interface section 309 to the IEEE1394 bus.

The display process of the television receiver 300 and the transmission process of the television receiver 300 through the interface section 309 are executed under the control of a central processing unit (CPU) 310. A memory 311 serving as a ROM storing programs necessary for control operation and a memory 312 serving as a work RAM are connected to the CPU 310. Also, operation information from an operation panel 314 and control information received by an infrared ray reception section 315 from a remote controller are supplied to the CPU 310 to allow the CPU 310 to conduct operation control in accordance with the operation information and the control information. Further, if the television receiver 300 receives control data such as an AV/C command to be described later through the IEEE1394 bus, the data is supplied to the CPU 310 to allow the CPU 310 to conduct operation control according to the control data.

Next, description will be given to data transmission states on the IEEE1394 buses 1a to 1d mutually connecting the respective devices 100 to 500.

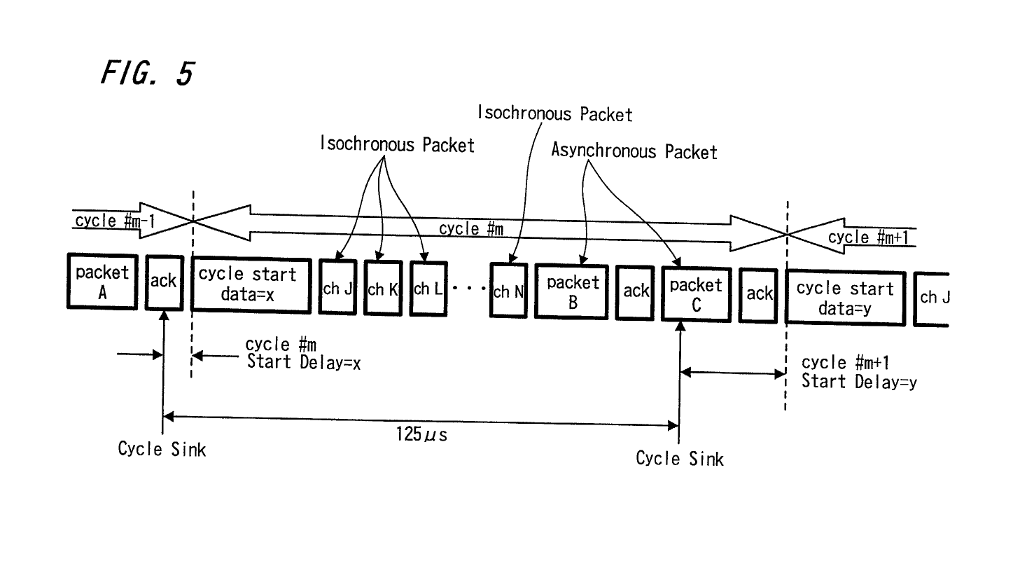

FIG. 5 shows the data transmission cycle structure of the devices connected by the IEEE1394 bus line. On the IEEE1394 bus line, data is divided into packets and transmitted in a time division manner with reference to a cycle having a length of 125 μs. This cycle is created by a cycle start signal supplied from the node (one of the devices connected by the buses) having a cycle master function. Isochronous packets secure a band (which is called so despite time units) necessary for data transmission from the start of all cycles. Due to this, isochronous transmission ensures data transmission within a certain time period. It is noted, however, that if a transmission error occurs, data is lost because no protection mechanism is provided. Asynchronous transmission for outputting asynchronous packets from a node which has secured a bus as a result of arbitration is conducted while isochronous transmission is not conducted in each cycle. Although asynchronous transmission ensures reliable transmission by using acknowledgement and retry, constant transmission timing cannot be obtained.

If a predetermined node conducts isochronous transmission, the node is required to correspond to the isochronous function. In addition, at least one of the nodes corresponding to the isochronous function is required to have a cycle master function. Besides, at least one of the nodes connected to the IEEE1394 serial bus is required to have an isochronous resource manager function.

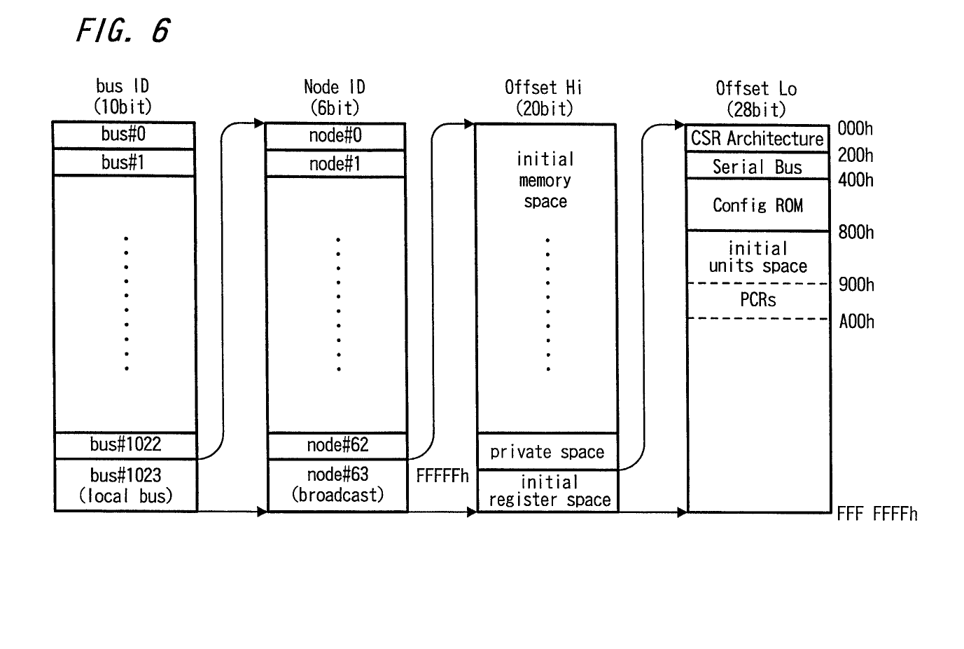

The IEEE1394 standard is compliant with a CSR (or Control & Status Register) architecture having a 64-bit address space specified by the ISO/IEC13213 standard. FIG. 6 is an explanatory view showing the address space structure of the CSR architecture. The first 16 bits are used for a node ID indicating each node on the IEEE1394 bus and the remaining 48 bits are used to designate address space given to the respective nodes. The first 16 bits are further divided into 10 bits for a bus ID and 6 bits for a physical ID (which is a node ID in a narrow sense). If all bits are 1, the address space is used for a special purpose, such that 1023 buses and 63 nodes can be designated.

The space specified by the first 20 bits of the address space specified by the remaining 48 bits is divided into an Initial Register Space, a Private Space, an Initial Memory Space and the like used by CSR specific registers of 2048 bytes, IEEE1394 specific registers and the like. The space specified by the remaining 28 bits is used as a Configuration ROM, an Initial Unit Space used for node specific purposes, a Plug Control Register (PCR) and the like if the space specified by the first 20 bits is used as the Initial Register Space.

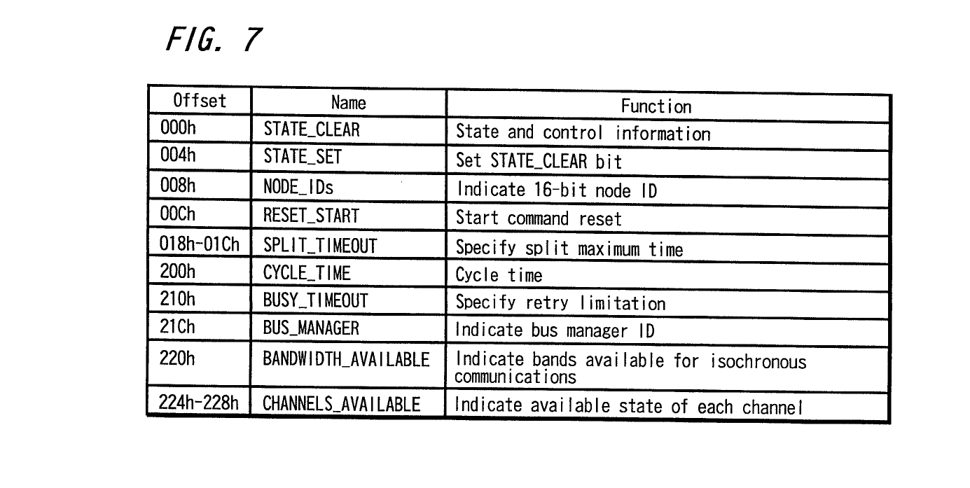

FIG. 7 is an explanatory view showing the offset addresses, names and functions of important CSR's. In FIG. 7, item ‘offset’ indicates an offset address close to address FFFFF0000000h (number with h put last represents the hexadecimal notation) at which the initial register space starts. A bandwidth available register having offset 220h indicates bands which can be allotted to isochronous communications. In this register, only the value of the node operating as the isochronous resource manager (IRM) is effective. That is, each node has the CSR's shown in FIG. 6, but only in the IRM is the bandwidth available register effective. In other words, the bandwidth available register is substantially owned only by the IRM. A maximum value is stored in the bandwidth available register if no bands are allotted to isochronous communications. Whenever bands are allotted thereto, the value decreases.

In a channel available register having offset 224h to 228h, 64 bits correspond to channel numbers 0 to 63, respectively. If the value of a bit is 0, it indicates that the corresponding channel is already allotted. The channel available register only of the node operating as the isochronous resource manager (IRS) is effective.

According to the IEEE1394a standard to be described later, this channel available register is also used as a channel management register for transmitting asynchronous stream packets.

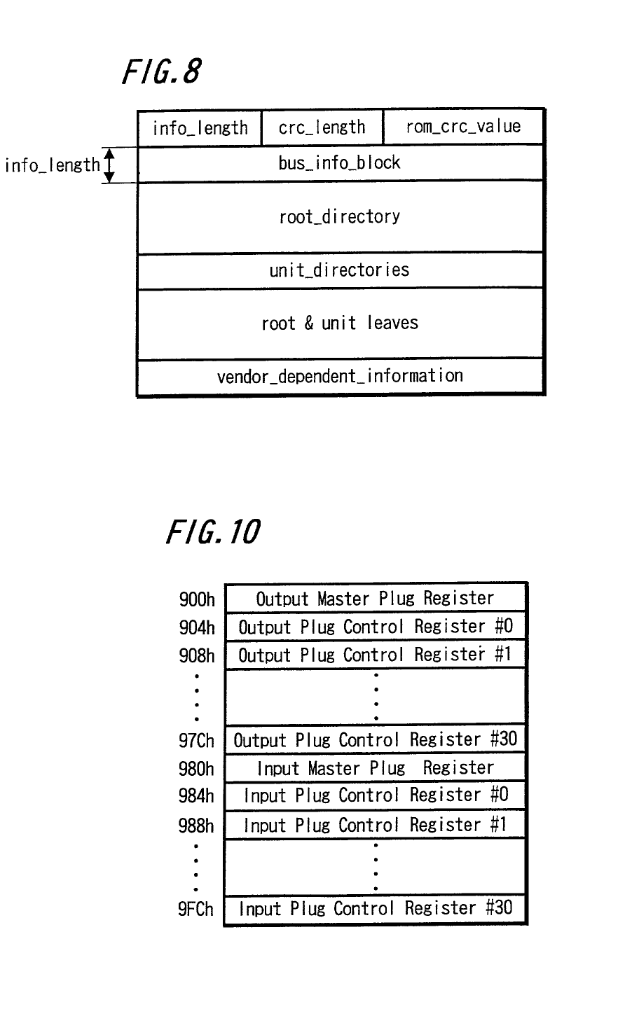

Returning to FIG. 6, the configuration ROM based on the general ROM format is arranged at addresses 200h to 400h in the initial register space. FIG. 8 is an explanatory view for the general ROM format. A node, which is an access unit on the IEEE1394 bus line, is capable of including a plurality of units operating independently of one another while using a common address space. Unit directories can indicate the software versions and positions of the respective units. While the positions of a bus info block and a root directory are fixed, the positions of the other blocks are designated by offset addresses.

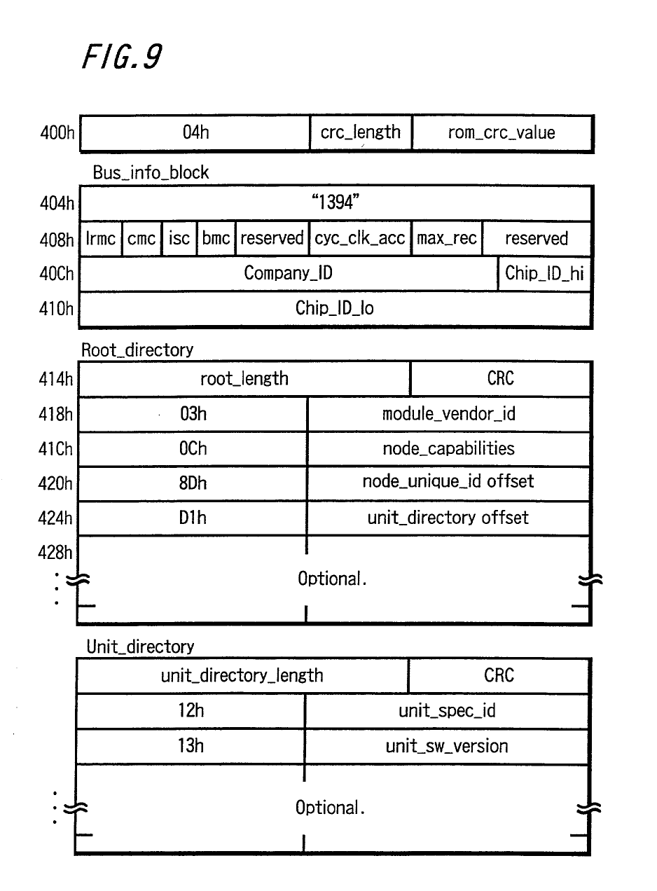

FIG. 9 shows the details of the bus info block, the root directory and the unit directories. An ID number indicating the manufacturer of a device is stored in a Company ID in the bus info block. An ID which is the only one on earth, not overlapped with the ID's of the other devices and specific to the subject device is stored in a Chip ID. Also, according to the IEC61833 standard, 00h, Aoh and 2Dh are written to the first octet, the second octet and the third octet of the unit spec ID of the unit directory of a device compliant with the IEC61883 standard, respectively. Further, 01h and 1 are written to the first octet and the LSB (Least Significant Bit) of the third octet of the unit switch version (unit sw version), respectively.

For purposes of input/output controlling of a device through the interface, the node has a PCR (Plug Control Register) specified by the IEC6183 standard at addresses 900h to 9FFh in the initial unit space shown in FIG. 6. This register virtually configures and substantiates the concept of plugs so as to create a signal path logically similar to an analog interface.

FIG. 10 is an explanatory view showing the constitution of the PCR. The PCR includes an oPCR (output Plug Control Register) representing an output plug and an iPCR (input Plug Control Register) representing an input plug. The PCR also includes an oMPR (output Master Plug Register) and an iMPR (input Master Plug Register) which registers indicate device specific information on the output plug and the input plug, respectively. Although each device does not have a plurality of oMPR's and iMPR's, it is possible that the PCR includes a plurality of oPCR's and iPCR's corresponding to individual plugs, depending on the capability of the device. The PCR shown in FIG. 10 includes 31 oPCR's and 31 iPCR's. The flow of isochronous data is controlled by operating the registers corresponding to these plugs.

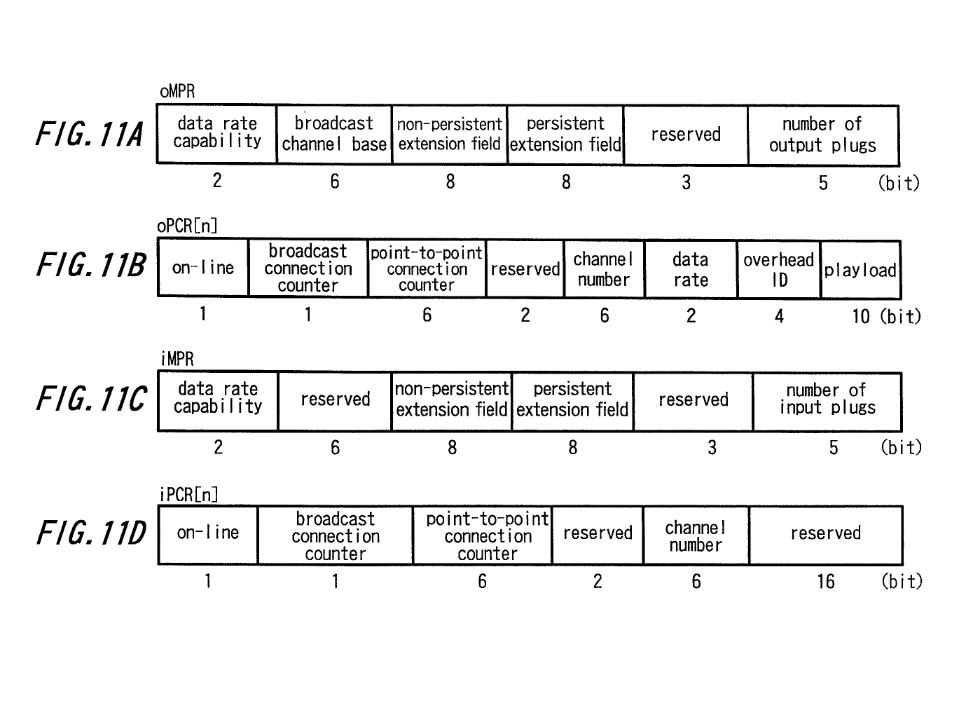

FIGS. 11A to 11D show the constitutions of the oMPR, oPCR, iMPR and iPCR, respectively. A code indicating the maximum transfer rate for isochronous data which the equipment can receive or transmit, is stored in an MSB-side 2-bit data rate capability of each oMPR and iMPR. The broadcast channel base of the oMPR specifies the number of a channel used for broadcast output.

A value indicating the number of output plugs, i.e., the number of oPCR's, is stored in an LSB-side 5-bit number of output plugs of the oMPR. A value indicating the number of input plugs, i.e., the number of iPCR's, is stored in an LSB-side 5-bit number of input plugs of the iMPR. A non-persistent extension field and a persistent extension field are regions defined for possible expansion in the future.

The MSB-side on-line of each oPCR and iPCR indicates a state in which the plug is used. If the on-line has a value 1, it indicates that the plug is on-line. If the on-line has a value 0, it indicates that the plug is off-line. If the plug is on-line, it indicates a state in which data can be transmitted using the plug. If the plug is off-line, it indicates a state in which data cannot be transmitted using the plug. The value of the broadcast connection counter or bcc of each oPCR and iPCR is 1 if a broadcast connection is established and 0 if no broadcast connection is established.

The value of the point-to-point connection counter or pcc having a width of 6 bits of each oPCR and iPCR represents the state of a point-to-point connection (PtoP connection) of the plug. The value of this point-to-point counter turns any one of 1 to 63 if a PtoP connection is established and turns 0 if no PtoP connection is established. Accordingly, if all the data values of the broadcast connection counter and the point-to-point connection counter or 7 bits in all are 0, it indicates that no connection with this plug is established. If the data value of at least 1 bit out of 7 bits is 1, it indicates that a connection with this plug is established.

The value of the channel number having a width of 6 bits of each oPCR and iPCR indicates the number of an isochronous channel to which the plug is connected. The value of the data rate having a width of 2 bits of the oPCR indicates the actual transfer rate of the packets of isochronous data output from the plug. For example, three or more transfer rates such as 100 Mbps (S100 mode), 200 Mbps (S200 mode) and 400 Mbps (S400 mode) are prepared and the value of the data rate indicates at which transfer rate the data is output with a connection at that time. A code stored in the overhead ID having a width of 4 bits of the oPCR is set to have a value in light of transmission delay which occurs when stream data is transmitted over isochronous communications. The value of the payload having a width of 10 bits of the oPCR indicates the magnitude of stream data transmitted with the plug in the units of quadlets. One quadlet is 4 bytes (4×8 bits=32 bits).

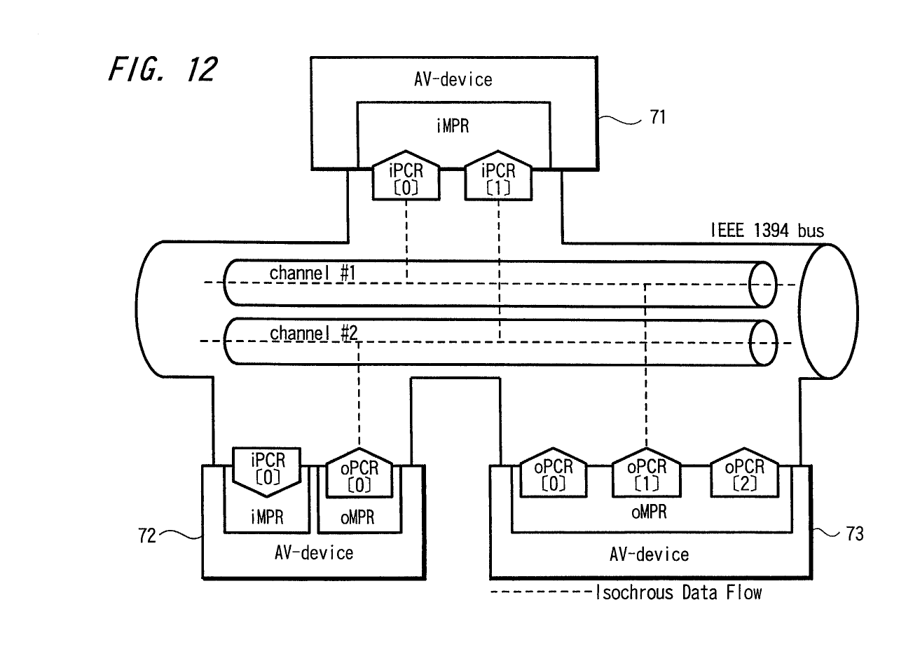

FIG. 12 shows the relationship among the plug, the plug control register and the isochronous channel. AV devices 71 to 73 are connected to one another by the IEEE1394 serial bus. Isochronous data for which the channel is designated by an oPCR [1] out of oPCR[0] to oPCR[2], for which the transfer rate and the number of oPCR's are specified by the oMPR of the AV device 73, is output to a channel #1 on the IEEE1394 serial bus. The input channel #1 is set by the iPCR[0] out of the iPCR[0] and the iPCR[1], for which the transfer rate and the number of iPCR's are specified by the iMPR of the AV device 71, and the AV device 71 reads the isochronous data output to the channel #1 on the IEEE1394 serial bus. Likewise, the AV device 72 outputs isochronous data to a channel #2 designated by the oPCR[0] and the AV device 71 reads the isochronous data from the channel #2 designated by the iPCR[1].

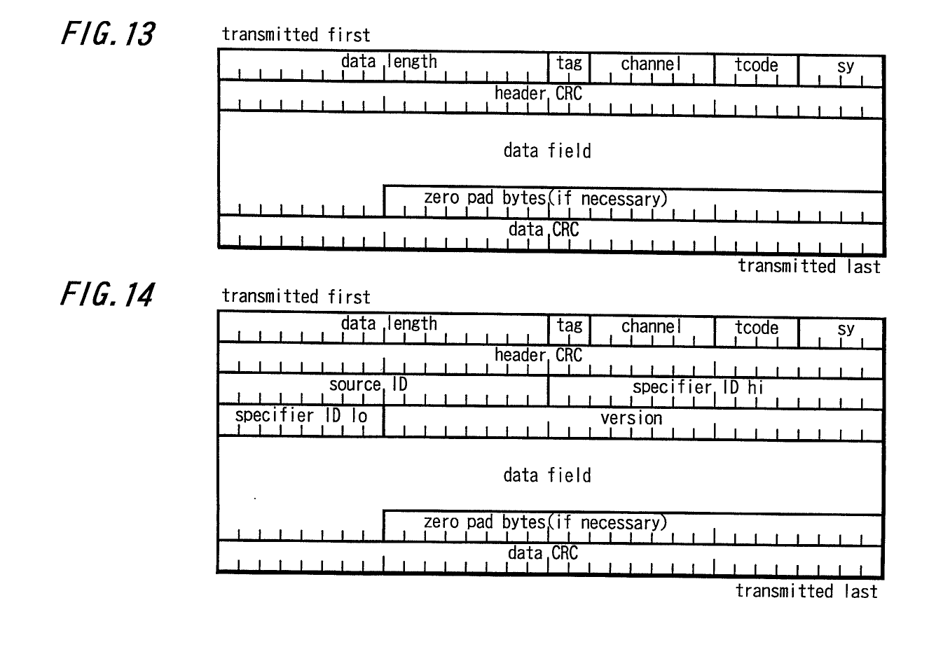

In this way, stream data is transmitted among the devices connected to one another by the IEEE1394 serial bus. The stream data transmission process described so far is to transmit stream data upon securing a band and a channel in an isochronous transfer mode. According to the IEEE1394a standard, stream data transmission is possible even in an asynchronous transfer mode. Next, the structure of a packet (or asynchronous stream packet) for stream data transmission in the asynchronous transfer mode proposed by the IEEE1394a standard will be described with reference to FIG. 13. This asynchronous stream packet is transmitted as the asynchronous packet shown in FIG. 5 and indicated as data in units of quadlets. The asynchronous stream packet is basically the same in constitution as the isochronous packet specified by the IEEE1394-1995 standard.

In the first one quadlet interval, which interval is set as a header, a data length (data length), a data format tag (tag), an asynchronous channel (channel), transaction code (tcode) and a synchronous code (sy) are arranged. In the next one quadlet interval, which interval is set as a header CRC (header CRC), an error detection cyclic code generated based on the data in the header interval is arranged. From the next quadlet interval, set as a data field or a payload, zero data is arranged on the final edge if necessary. In the last one quadlet interval, which interval is set as a data CRC (data CRC), an error detection cyclic code generated based on the data in the data field interval is arranged. The maximum size of the data field interval is determined according to each data rate.

The number of channels of this asynchronous stream packet is allotted by the asynchronous resource manager (or IRM). That is, the number of channels is allotted by the channel available register in the IRM register shown in FIG. 7 already described above.

By transmitting this asynchronous stream packet onto the bus, the packet is broadcast-transmitted to the respective nodes in the network. Accordingly, the intervals in which this asynchronous stream packet is transmitted is set as intervals in which the data is broadcast-communicated to all the nodes in the asynchronous transfer mode.

As this asynchronous stream packet, there is further proposed a global asynchronous stream packet (to be referred to as “GASP” hereinafter). The GASP is a packet corresponding to a bus bridge standard. The asynchronous stream packet can be transmitted not only onto the same bus but also onto the other buses connected by bridges.

FIG. 14 shows the constitution of the GASP. The header constitution of the GASP is the same as that of the asynchronous stream packet, i.e., data is added to a payload, except that a value (e.g., “11”) indicating that the packet is a GASP is arranged in the tag interval. As the channel number, a certain value (e.g., “011111”) is arranged. Data added to the payload interval includes a source ID indicating the node ID of the node which transmits the data, a specifier ID which is a code allotted to the manufacturer of the device and version data which is a code on the meaning of the use of the data field. Since the specifier ID is arranged to two separate quadlet intervals, the first half 16 bits are arranged as a Specifier ID hi in one quadlet and the second half 8 bits are arranged as a Specifier ID lo in the other quadlet. Then, the following part is set as a data field, the data CRC is arranged in the last one quadlet interval.

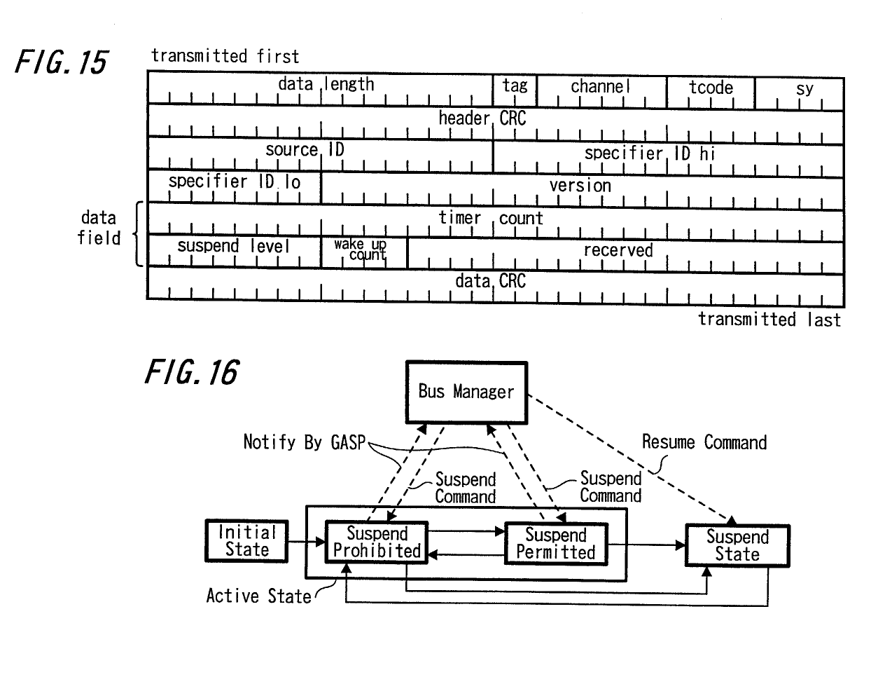

In this embodiment, using the GASP, data as to whether or not the respective nodes in the network can be set in suspend states is transmitted. FIG. 15 shows one example of a packet structure if this data is transmitted.

In the example shown in FIG. 15, data on suspend states is arranged in data field intervals (2 quadlet intervals in this example) of the GASP shown in FIG. 14. Namely, timer count data is arranged in the 1 quadlet interval. In the next 1 quadlet interval, suspend level data is arranged using 8 bits, wakeup count data is arranged using 4 bits and the remaining intervals are reserved.

The 32-bit timer count indicates the time from when the node or device is placed in a suspend state until the node or device turns into a resume state and returns to an active state by, for example, a value in seconds. At a suspend level of 8 bits (0 to 7th bits), 0th bit is data indicating whether or not suspend is possible, the 1^{st} bit is data indicating whether or not there is timer count, 2^{nd} to 3rd are priority data, 4th to 7th are reserved. As for 0th bit data indicating whether or not suspend is possible, if the device can be, for example, suspended, the data is set at “1” data and if the device cannot be suspended, the data is set at “0” data. In this example, if the device is started from a power off state or turns into an active state when resumed, the device is always set in a suspend prohibition state.

The 4-bit wakeup count indicates the number of times the active state of the device is resumed from a suspend state and counts up one whenever a resumption of the device occurs.

Next, description will be given to a process for controlling a suspend state in the network based on the notification of data on the permission/prohibition of suspend state constituted as stated above, with reference to FIG. 16 and the following. First, description will be given to the transition of each node in the network from an active state to a suspend state with reference to FIG. 16. Suspend state control is executed under the control of the bus manager in the network. One arbitrary node in the network is set as this bus manager. In this case, for example, the node A in the network shown in FIG. 1 is set as a bus manager.

Each node in the network can be set in at least two states, i.e., an active state in which the node can carry out communications through the bus and a suspend state in which the node is dormant while the node cannot carry out communications through the bus. By transmitting a suspend setting command to each node in the network, the bus manager can suspend any node in the network. Further, by transmitting a resume command, each node is allowed to be started from the suspend state. It is noted that a node for issuing a suspend command is set based on a determination to be described later in this embodiment.

Each node (or device) is in an active state initially, for example, when the node is turned on. If the node turns active in the initial state, the node is set to be always prohibited from being suspended as the suspend permission/prohibition state of the node or device.

Using the GASP shown in FIG. 15 stated above, each node broadcast-transmits data on suspend permission/prohibition in the network. The bus manager determines the data thus broadcast-transmitted. If it is necessary to set part of the nodes in the network in suspend states, the bus manager transmits a suspend command to the node which, the bus manager determines, is most preferably set in a suspend state. When the suspend command is transmitted, the node receiving the command turns into a suspend state. The node in the suspend state is sometimes resumed automatically by a process to be described later. If necessary, the bus manager can transmit a resume command to the node to turn the node into an active state. Even if the node is resumed to turn into an active state, the node is set to be always prohibited from being suspended.

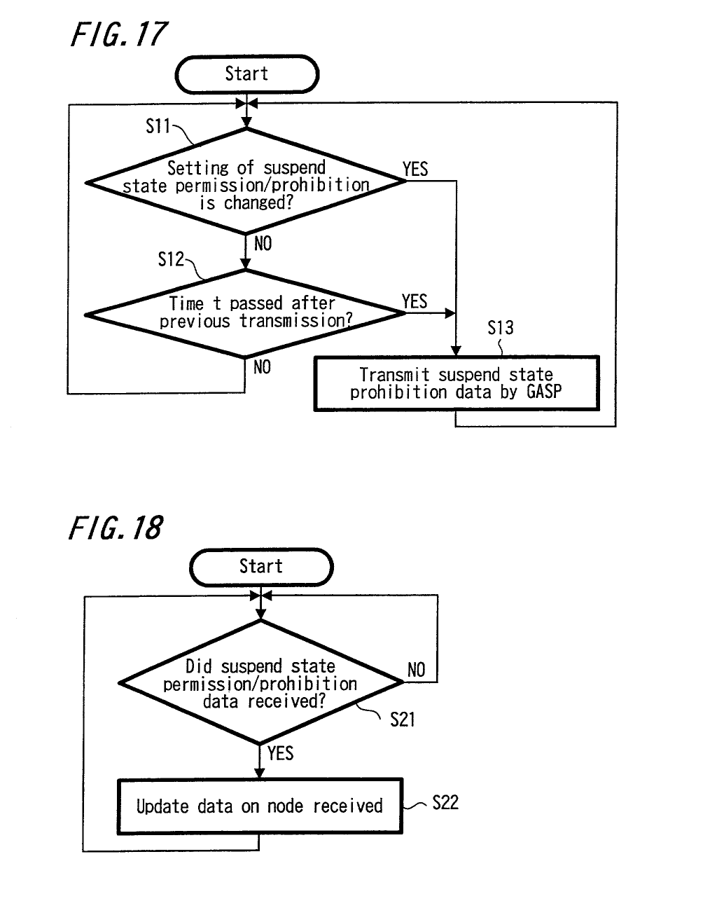

The flow chart of FIG. 17 shows a timing setting process for transmitting data on the permission/prohibition of a suspend state setting from each node using the GASP. In this example, it is first determined whether the setting of the suspend state permission/prohibition for the device has changed (in step S11). If the suspend permission/prohibition setting has changed, the process moves to step S13, in which the GASP shown in FIG. 15 is output onto the bus at a timing at which the packet can be transmitted.

If the suspend state permission/prohibition setting has not changed in step S11, it is determined whether a preset time t has passed after the transmission of data on the previous suspend permission/prohibition setting (in step S12). When the time t has passed, the process moves to step S13 in which the GASP shown in FIG. 15 is output onto the bus at a timing at which the packet can be transmitted. If it is determined that the time t has not passed yet in step S12, the process returns to the determination of step S11. The time t may be set, for example, at about several minutes.

A change in the suspend permission/prohibition setting in the device may occur when, for example, a state in which the device or the node does not carry out any operation continues for a certain time. In the case of the video cassette recorder 300 constituted as the node C shown in FIG. 1, for example, if a state in which the device 300 does not carry out an operation such as reproduction or recording, continues for a certain time, the suspend prohibition state of the device may possibly be changed to a suspend permission state. In that case, if a timer recording reservation is made, the device may be prohibited from being suspended until the timer recording is finished.

As can be seen, the suspend state permission/prohibition setting data output onto the bus is received by and stored in the bus manager. That is, the bus manager prepares a table of data on the states of the respective nodes in the network and sequentially updates the data in the table. The flow chart of FIG. 18 shows the data reception and update processes of the bus manager. The bus manager determines whether the bus manager has received suspend state prohibition/permission setting data (in step S21). If the setting data has been received, the bus manager updates data in the table with respect to the node which transmitted the data (in step S22).

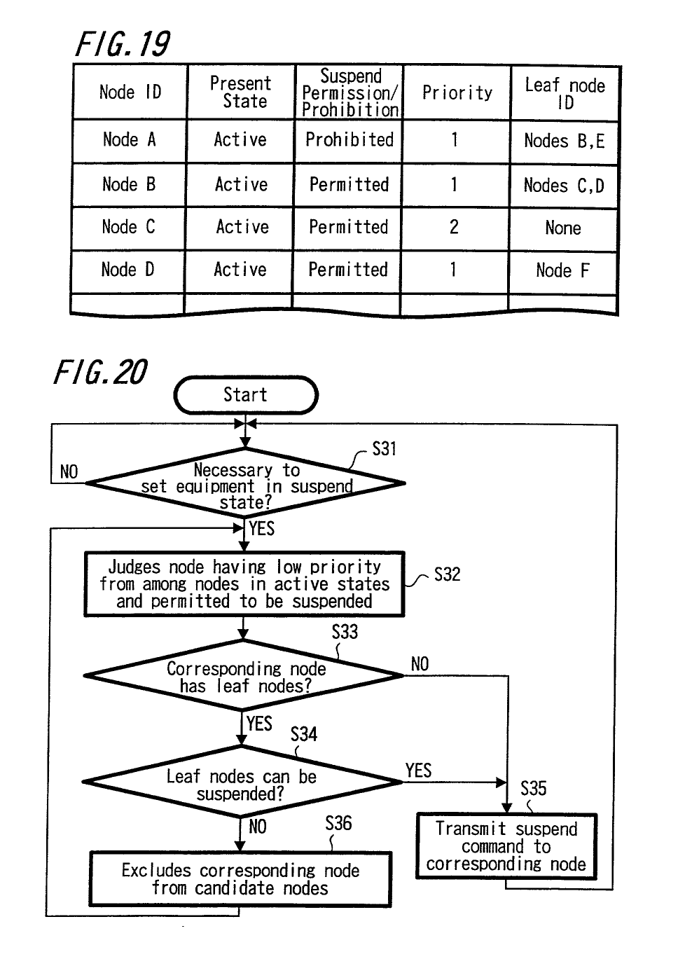

FIG. 19 shows an example of data on the suspend states of the respective nodes stored in the memory connected to a control section in the bus manager. In this example, the memory holds pieces of data indicating whether a node is in an active state or in a suspend state as a present state, whether suspend is permitted or prohibited as suspend permission/prohibition, a priority, and, if the node has a leaf node, the node ID of the leaf node for each node ID. These pieces of data are updated every time the bus manager receives data from the respective nodes as stated in the flow chart of FIG. 18.

The data on the leaf node ID is generated based on the network constitution which the bus manager determines. The leaf node means herein a node connected to the terminal side (opposite side to the bus manager) of the node. In case of the constitution shown in FIG. 1, for example, if the bus manager is the node A, then the leaf nodes of the node A are the nodes B and E, the leaf nodes of the node B are the node C and D and the leaf node of the node D is the node F.

While only the leaf nodes directly connected to the terminal sides of the nodes concerned are shown herein, all the leaf nodes connected to the terminal sides of the respective nodes may be held as data. For example, by setting the nodes B, C, D, E and F as the leaf nodes of the node A, and setting the nodes C, D and F as the leaf nodes of the node B, all the nodes connected to the terminal sides of the nodes can be shown. It is noted, however, that even with the data constituted as shown in FIG. 19, it is possible to determine all the nodes connected to the terminal sides of the respective nodes by tracking the data on the nodes in due order. Furthermore, in the example of FIG. 19, the respective nodes are distinguished from one another by their node ID's. However, since the node ID's may possibly be changed if the bus is reset, the data on each node may be managed according to node specific data such as a node unique ID.

Next, description will be given to a process for controlling the suspend states of the respective devices in the network based on the data held in the bus manager as stated above, with reference to the flow chart of FIG. 20.

First, the bus manager determines whether it is necessary to set some of the devices in the network in suspend states (in step S31) . To make this determination, if the number of devices connected in the network increases and it is determined that transmission delay increases on the bus to some extent, then the bus manager may determine that it is necessary to set some devices in suspend states. Alternatively, without making the determination as stated above, the bus manager may regularly determine that it is necessary to set some devices in suspend states.

If it is determined that it is necessary to make a suspend state setting in step S31, the bus manager determines which node is to be suspended from the data on the suspend states held in the bus manager. That is, first, the bus manager determines which node has the lowest priority from among the nodes which are not in active states and are permitted to be suspended (in step S32). The bus manager then determines whether the node having the lowest priority, which has been determined in step S32, has leaf nodes (in step S33). If the node has leaf nodes, the bus manager determines whether or not all the leaf nodes connected to the terminal side of the node are permitted to be suspended (in step S34).

If the bus manager determines that the node has no leaf node in step S33 or determines that all the leaf nodes are permitted to be suspended in step S34, then the bus manager transmits a suspend command to the node to set the node in a suspend state (in step S35). At this moment, if the node has leaf nodes, the bus manager may transmit the suspend command to the leaf nodes as well.

If the bus manager determines in step S34 that some of the leaf nodes are prohibited from being suspended, the bus manager excludes the node from the candidate nodes which can be suspended and returns to step S32, in which step the bus manger selects appropriate nodes again from the remaining candidate nodes.

As a result of the process stated above, only when the bus manager determines whether a suspend state setting can be made for each node in the network and determines that the suspend state setting can be made, then the bus manager can transmit a command to the node and set the node in a suspend state, thereby making it possible to set an arbitrary device in the network in a suspend state.

Here, one example of a concrete process under the network constitution shown in FIG. 1 will be described. If the node A or IRD 100 is the bus manager and the node B or television receiver 200 is in an inoperative state and can be suspended, then the television receiver 200 can be set in a suspend state in response to an instruction from the bus manager. At this moment, if the node C or video cassette recorder 300 connected to the node B is recording, the IRD 100 and the video cassette recorder 300 cannot transmit data between them when the television receiver 200 is turned to a suspend state. However, by carrying out the process shown in the flow chart of FIG. 20, it is possible to set only the devices which can be set in a suspend state in a suspend state without turning the devices between the bus manager and the leaf nodes to suspend states if the leaf nodes are operating and prohibited from being suspended.

As can be seen, since some of the devices in the network can be set in suspend states, it is possible to reduce transmission delay in the network and to enhance the transmission efficiency of the network. Further, since at least a processing section of the devices set in a suspend state, for carrying out communication through ports is turned off, it is possible to reduce power consumption accordingly. Moreover, it is possible to reduce unnecessary radiation from the devices set in a suspend state or the cables connected to the devices. Besides, since part of the nodes can be efficiently set in suspend states as stated above, processes can be carried out without deteriorating transmission efficiency even if a new node is added to the network.

Furthermore, by setting the device connected in the network by optical transmission in a suspend state, such as the node F connected to the node D shown in FIG. 1, it is possible to stop the operation of an optical signal transmission section and reception section while the device is in a suspend state. Thus, the service lives of a laser light source or a light emission diode required as the optical signal transmission section and a light receiving element required as the optical signal reception section can be lengthened.

If a specific device is set in a suspend state by issuing a suspend command and GASP data indicates that the device takes timer count, the device is automatically resumed after the time indicated by the timer count elapses and returns to an active state, thereby making it possible for the device to carry out communications in the network. Further, a device which is not set to take timer count may be returned to an active state at appropriate timing by issuing a resume command from the bus manager. In addition, a device which takes timer count can be forcibly returned to an active state by issuing a resume command while the device is taking timer count. It is noted, however, if the device stops operation completely in a suspend state and the bus manager cannot transmit a command to the device, it is necessary to resume the operation of the device by a method other than the transmission of a resume command.

In the above-stated embodiment, data on suspend state permission/prohibition is transmitted as a broadcast communication command using the GASP in the network connected by the IEEE1394 bus. Alternatively, using another broadcast communication packet, data on suspend state permission/prohibition may be transmitted.

Further, the network constitution should not be limited to the constitution according to the above-stated IEEE1394a system. The present invention is also applicable to a network constitution according to another IEEE1394 system or a network constitution according to a system other than the IEEE1394 system. In the latter case, transmission paths among the respective devices may be the above-stated bus line for directly connecting the respective devices to one another or may be radio transmission paths using radio signals besides the optical transmission paths. In the case of radio transmission paths, if a plurality of devices constitute a network using a wireless network communication system according to, for example, the IEEE1394 system or a radio communication standard referred to as Bluetooth, the respective devices in the network may carry out the same suspend and resume processes.

Moreover, in the above-stated embodiments, the data on suspend state setting permission/prohibition is transmitted from the respective nodes in the network when the state of each device has a change or when a preset time has passed after the previous data transmission. Alternatively, the data may be transmitted only when the state of the device has a change. Conversely, the data may be transmitted almost at predetermined time intervals irrespective of whether the state of the device has changed.

According to the transmission method of a first aspect of the invention, it is possible to transmit data as to whether each device can be set in a suspend state from each device in a network to a controller using a broadcast communications transmission interval, and it is possible for the controller side to determine whether each device connected in the network can be set in the suspend state.

According to a variant of the first aspect of the invention, a notification is transmitted when a state of whether the device can be set in the suspend state is changed. By doing so, the state of each device which the controller side grasps does not differ from the actual state of each device and the controller side can ensure grasping the state of each device.

According to a further variant of the first aspect of the invention, the notification is transmitted regularly almost at predetermined time intervals, whereby the controller side can grasp the state of each device at any time.

According to yet a further variant of the first aspect of the invention, data on suspend state setting priorities is added when the notification is transmitted. By doing so, if the controller side issues a command to set each device in the suspend state, the controller can judge from which devices the suspend state setting can be made.

According to still another variant of the first aspect of the invention, data on the time since the suspend state has been set until the active state is resumed is added to the notification. By doing so, if the controller makes a suspend state setting, the controller can judge the time from the resumption of the active state of the device until the equipment is returned.

According to a still further variant of the first aspect of the invention, the devices judged by the controller to be permitted to be set in the suspend state based on the notification are set in the suspend state in response to a command from the controller. By doing so, if the controller sets the devices in the network in the suspend state, the controller can properly make such settings only to the necessary devices.

According to a variant of this last described feature of the invention, a suspend state setting command is transmitted to the equipment judged to be permitted to be set in the suspend state when it is judged that a constitution of the network is such that the other equipment is connected in a predetermined state and when the other equipment can be set in the suspend state. Thus, by setting specific devices in the network in suspend states, it is possible to prevent a situation in which communication with the other equipment in the network cannot be carried out.

According to a transmission system of a second aspect of the invention, the first device in the network can transmit data as to whether the first device can be set in a suspend state to the second device using a broadcast communications transmission interval, and the second device side can judge whether the first device can be set in the suspend state. Thus, if the second device controls the state of the first device, the second device can exert control based on a proper judgment.

According to a variant of the second aspect of the invention, the first device transmits the data as to whether the first device can be set in the suspend state from the output means when a state of whether the first device can be set in the suspend state is changed. By doing so, the second device can properly judge whether or not the first device can be controlled to be in the suspend state with a minimum necessary data transmission.

According to a further variant of the second aspect of the invention, the first device transmits the data as to whether the first device can be set in the suspend state from the output means regularly almost at predetermined time intervals, whereby the second device side can grasp the state of the first device at any time.

According to a still further variant of the second aspect of the invention, the first device holds data on suspend state setting priorities in the data holding means, and adds the data on suspend state setting priorities to the data as to whether the first device can be set in the suspend state, which data is transmitted from the output means. By doing so, if the second device controls the first device to be in the suspend state, the second device can judge the priority of the first device in the network and thereby appropriately control the first device in accordance with the state.

According to yet another variant of the second aspect of the invention, the first device holds data in the holding means on the time since the suspend state has been set until the active state is resumed, and the active state is resumed when the time indicated by the data has passed after setting the first device in the suspend state under the control of the controller of the second device. By doing so, the second device can automatically set the first device in the suspend state and set the active state of the first device to be resumed after a predetermined time only by transmitting a suspend state setting command to the first device. In this case, the second device can automatically judge the timing at which the active state of the first device is resumed from the transmitted time data and properly judge the state of the first device.

According to a still further variant of the second aspect of the invention, the controller of the second device conducts control for setting the first device in the suspend state when the controller judges that a constitution of the network is such that a third device is connected to the first device in a predetermined state and when the controller judges that both the first and third devices can be set in the suspend state. By doing so, if the third device cannot be set in the suspend state, the first device is set in the suspend state, thereby making it possible to prevent a situation in which the second and third devices cannot carry out communications.

According to a transmission apparatus of a third aspect of the invention, the data as to whether the transmission apparatus can be set in a suspend state can be transmitted to the other equipment connected in the network over broadcast communications, and it is possible to properly conduct control for setting the transmission apparatus in the suspend state in the network based on the transmitted data.

According to a variant of the third aspect of the invention, the output means outputs the data as to whether the transmission apparatus can be set in the suspend state when the data held by the data holding means as to whether the transmission apparatus can be set in the suspend state is changed. By doing so, the other equipment in the network can properly grasp the state of this transmission apparatus.

According to another variant of the third aspect of the invention, the output means outputs the data as to whether the transmission apparatus can be set in the suspend state regularly almost at predetermined time intervals. By doing so, the other equipment in the network can grasp the state of this transmission apparatus at any time.

According to a further variant of the third aspect of the invention, the data holding means holds data on suspend state setting priorities, and the data on suspend state setting priorities is added to the data as to whether the transmission apparatus can be set in the suspend state. By doing so, the other equipment in the network can judge the priorities based on this data and conduct appropriate control in accordance with the state of the network at that time.

According to still another variant of the third aspect of the invention, the data holding means holds data on the time since the suspend state has been set until resume for releasing the suspend state, and the data on the time is added to the data output from the output means as to whether the transmission apparatus can be set in the suspend state. By doing so, when this transmission apparatus is automatically resumed after being set in the suspend state, the other equipment in the network can grasp the situation.

According to a transmission control apparatus of a fourth aspect of the invention, the transmission control apparatus can judge whether each device in the network can be set in a suspend state from data transmitted from the respective devices in the network over broadcast communications, and can transmit a suspend state setting command only to the devices judged to be permitted to be set in the suspend state from the judgment, thereby making it possible to properly control the respective devices in the network.

According to a variant of the fourth aspect of the invention, the controller sets the equipment receiving the command based on priority data added to the data received by the reception means as to whether the devices can be set in the suspend state, thereby making it possible to set priorities and conduct proper control.

According to a further variant of the fourth aspect of the invention, the controller allows generating a command to set the control target equipment judged to be permitted to be set in the suspend state in the suspend state and allows the output means to transmit the command to the control target equipment if the constitution of the network is such that the other equipment is connected in a predetermined state and when it is judged that the other equipment can be also set in the suspend state. By doing so, if the other equipment cannot be set in the suspend state, the control target equipment is set in the suspend state, thereby making it possible to prevent a situation in which the transmission control apparatus and the other equipment stated above cannot carry out communications.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for transmitting data among a plurality of devices connected to a network under control of a controller, the method comprising:
using a broadcast communications transmission interval, transmitting from each of the plurality of devices in the network suspend state data indicating whether the transmitting device can be set in a suspend state; and
receiving the suspend state data in the controller.

2. The transmission method according to claim 1, wherein
the transmitting step includes transmitting the suspend state data when a state of whether the transmitting device can be set in the suspend state is changed.

3. The transmission method according to claim 1, wherein
the transmitting step includes transmitting the suspend state data regularly almost at predetermined time intervals.

4. The transmission method according to claim 1, wherein
the suspend state data includes data on suspend state setting priorities.

5. The transmission method according to claim 1, wherein
the suspend state data includes data on the time from when the transmitting device is set in the suspend state until the transmitting device is released from the suspend state to an active state.

6. The transmission method according to claim 1, further comprising:
determining in the controller which of the plurality of devices may be set in the suspend state on the basis of the suspend state data; and
sending a command from the controller to set in the suspend state selected devices which the controller determines may be set in the suspend state.

7. The transmission method according to claim 6, wherein
the command is sent to the selected devices when it is determined that the network includes at least one device other than the selected ones of the devices connected to the network in a predetermined state and that the at least one device can be set in the suspend state.

8. A transmission system, comprising:
a plurality of devices connected to a network so that said plurality of devices can transmit data to one another, said plurality of devices including a first device and a second device;
said first device including:
a memory for holding suspend state data indicating whether each of said plurality of devices can be set in a suspend state; and
an output unit operable to output said suspend state data to a broadcast communications transmission interval of said network; and
said second device including:
a receiver operable to receive said suspend state data output to said network; and
a controller operable to determine whether said first device can be set in said suspend state based on said suspend state data received by said receiver, and to control said first device based on said determination.

9. The transmission system according to claim 8, wherein
said first device transmits said suspend state data from said output unit for a selected one of said devices when a state of whether said selected one of said devices can be set in said suspend state is changed.

10. The transmission system according to claim 8, wherein
said first device transmits said suspend state data from said output unit regularly almost at predetermined time intervals.

11. The transmission system according to claim 8, wherein
said memory holds priority data on suspend state setting priorities for said plurality of devices, and adds said priority data to said suspend state data for each of said plurality of devices

12. The transmission system according to claim 8, wherein
said memory holds time data for selected ones of said plurality of devices, said time data for a specific device including a time, beginning when said specific device is set in said suspend state, for releasing said specific device from said suspend state to an active state; and
said controller controls the release of said specific device from said suspend state to said active state when said time has elapsed.

13. The transmission system according to claim 8, wherein
said controller controls the setting of said first device in said suspend state when said controller determines that said network includes a third one of said plurality of devices connected to said first device in a predetermined state and that both said first device and said third one of said devices can be set in said suspend state.

14. A transmission apparatus connected to a network, comprising:
a memory operable to hold suspend state data indicating whether said transmission apparatus can be set in a suspend state; and
an output unit operable to output said suspend state data held by said memory to a broadcast communications transmission interval of the network.

15. The transmission apparatus according to claim 14, wherein
said output unit outputs said suspend state data when said suspend state data held by said memory is changed.

16. The transmission apparatus according to claim 14, wherein
said output unit outputs said suspend state data regularly almost at predetermined time intervals.

17. The transmission apparatus according to claim 14, wherein
said memory holds priority data on suspend state setting priorities; and
said priority data is added to said suspend state data output from said output unit.

18. The transmission apparatus according to claim 14, wherein
said memory holds time data including a time, beginning when said transmission apparatus is set in said suspend state, for releasing said transmission apparatus from said suspend state to an active state; and
said time data is added to said suspend state data output from said output unit.

19. A transmission control apparatus for controlling transmission among a plurality of devices in a network, the plurality of devices being mutually connected in a data transmittable state, said transmission control apparatus comprising:
a receiver operable to receive suspend state data transmitted to a broadcast communications transmission interval of the network, said suspend state data indicating whether each of the plurality of devices can be set in a suspend state;
a controller operable to determine whether each of the plurality of devices in the network can be set in said suspend state based on said suspend state data received by said receiver, and to generate a command for controlling a state of each of said plurality of devices based on said determination; and
a transmitter operable to transmit said commands to the network.

20. The transmission control apparatus according to claim 19, wherein
said controller controls said transmitter to transmit said commands based on priority data added to said suspend state data received by the said receiver.

21. The transmission control apparatus according to claim 19, wherein
said controller is operable to generate a suspend command to set a target device in said suspend state when said suspend state data indicates that said target device can be set in said suspend state, and is operable to control said transmitter to transmit said suspend command if the network includes another device connected to the network in a predetermined state and it is determined that said another device can be set in said suspend state.
